(19) United States
(12) Patent Application Publication
(10) Pub. No.: US 2013/0250040 A1
(43) Pub. Date: Sep. 26, 2013

(54) Capturing and Displaying Stereoscopic Panoramic Images

(71) Applicants: Ilia Vitsnudel, Even Yehoda (IL); Noam Sorek, Zichron Yacoov (IL)

(72) Inventors: Ilia Vitsnudel, Even Yehoda (IL); Noam Sorek, Zichron Yacoov (IL)

(73) Assignee: BROADCOM CORPORATION, Irvine, CA (US)

(21) Appl. No.: 13/428,028

(22) Filed: Mar. 23, 2012

(51) Int. Cl. H04N 13/02

(52) U.S. Cl. 348/36; 348/E13.074

(57) ABSTRACT

Disclosed are various embodiments of a stereoscopic panoramic camera device, which can include camera devices, positioned about a center point. The camera devices capture image data corresponding to a 360 degree field of view around a center point. Image capture logic initiates capture of image data by the camera devices, which corresponds to the 360 degree field of view. A stereoscopic panoramic image of the 360 degree field of view is generated using stereoscopic information for sectors surrounding the center point, where the stereoscopic information is generated from adjacent camera devices having an overlapping field of view.

### BACKGROUND

Panoramic images are employed in various applications to present a 360 degree field of view around a center point. Stereoscopic imagery and video are employed in various applications to present a three dimensional representation of a scene by capturing imagery presented to the right and left eyes, respectively, of an observer. Depth maps can be generated from stereoscopic imagery from which distance information to objects captured in a scene can be derived.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a drawing of a stereoscopic panoramic image camera device according to various embodiments of the disclosure.

FIGS. 2A-2B are drawings of one configuration of the stereoscopic panoramic camera device of FIG. 1 according to various embodiments of the disclosure.

FIG. 3 is a drawing of an alternative configuration of the stereoscopic panoramic camera device of FIG. 1 according to various embodiments of the disclosure.

FIG. 4 is a drawing illustrating assembling of a stereoscopic panoramic image according to various embodiments of the disclosure.

FIGS. 5-6 are drawings illustrating application of a depth map to display a stereoscopic panoramic image according to various embodiments of the disclosure.

FIG. 7 is a flowchart providing an example of the operation of the stereoscopic panoramic camera device according to an embodiment of the present disclosure.

### DETAILED DESCRIPTION

Embodiments of the present disclosure relate to systems and methods that can be executed in an image capture device or camera device (e.g., still image capture devices, video cameras, still and video multi-function camera devices, etc.). Additionally, embodiments of the present disclosure relate to other systems and methods in which image analysis systems are employed, such as in object detection systems, automotive systems, robotics systems, or any other systems in which depth map analysis can be employed. The present disclosure is directed to capturing and displaying stereoscopic panoramic images. More specifically, embodiments of the disclosure are directed to systems and methods of capturing stereoscopic panoramic images with various types of camera devices that involve various numbers of image sensors and/or lens systems in various arrangements, orientations and configurations.

A camera device can include or be incorporated within a camera, video camera, a mobile device with an integrated camera device, set top box, game unit, gaming console, web cameras, wireless or wired access points and routers, laptop computer, modems, tablet computers, videoconferencing devices, automotive applications, augmented reality applications, or any other mobile or stationary devices suitable to capturing imagery and/or video as can be appreciated. In some embodiments, a camera device according to an embodiment of the disclosure can be integrated within a device such as a smartphone, tablet computing system, laptop computer, desktop computer, or any other computing device that has the capability to receive and/or capture imagery via image capture hardware.

In the context of the present disclosure, camera device hardware can include components such as lenses, image sensors, or imagers, (e.g., charge coupled devices, CMOS image sensor, etc.), processor(s), image signal processor(s) (e.g., digital signal processor(s)), a main processor, memory, mass storage, or any other hardware, processing circuitry or software components that can facilitate capture of imagery and/or video. In some embodiments, a digital signal processor can be incorporated as a part of a main processor in a camera device module that is in turn incorporated into a device having its own processor, memory and other components.

A camera device according to an embodiment of the disclosure can provide a user interface via a display that is integrated into the camera device and/or housed independently thereof. The display can be integrated with a mobile device, such as a smartphone and/or tablet computing device, and can include a touchscreen input device (e.g., a capacitive touchscreen, etc.) with which a user may interact with the user interface that is presented thereon. The camera device hardware can also include one or more buttons, dials, toggles, switches, or other input devices with which the user can interact with software or firmware executed in the camera device.

A camera device according to an embodiment of the disclosure can also be integrated within an automobile, robotic system, videoconferencing system, or any other types of systems in which image capture applications, particularly panoramic image capture applications can be included. For example, in an automotive application, an embodiment of the disclosure can be employed to capture stereoscopic panoramic imagery of a 360 degree field of view around an automobile and facilitate collision detection from a depth map generated from captured stereoscopic panoramic imagery. As another example, in a robotics application, an embodiment of the disclosure an embodiment of the disclosure can be employed to capture stereoscopic panoramic imagery of a 360 degree field of view around a robotic device and facilitate object detection and avoidance from a depth map generated from captured stereoscopic panoramic imagery. In a videoconferencing system, an embodiment of the disclosure can be employed to capture stereoscopic panoramic imagery of a 360 degree field of view around a videoconferencing camera device and facilitate reproduction of such a scene for videoconferencing purposes.

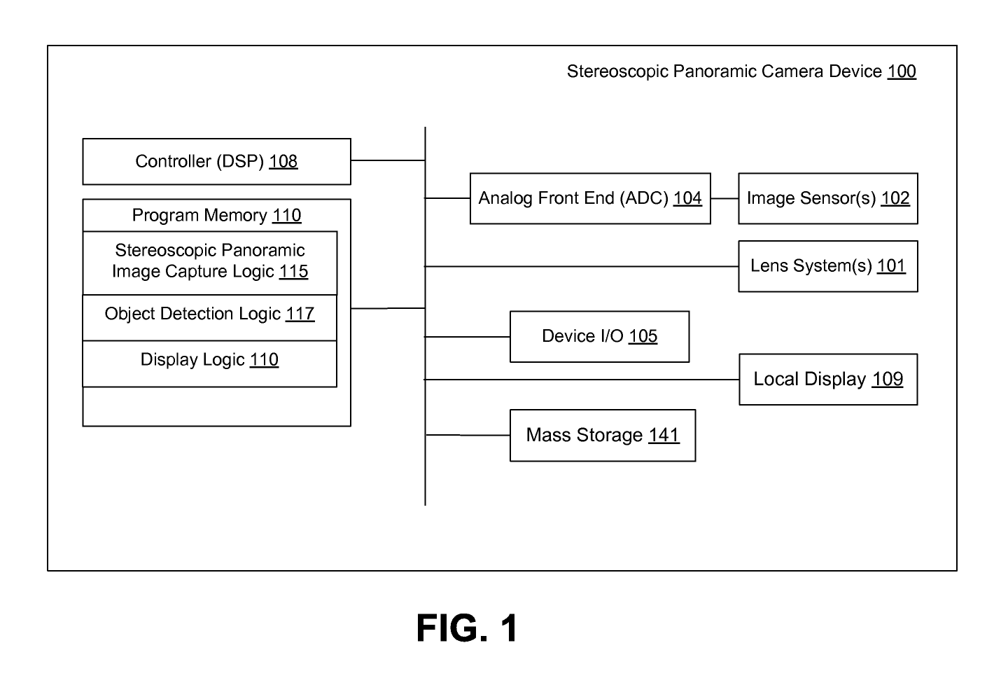

Accordingly, reference is now made to FIG. 1, which illustrates an embodiment of a stereoscopic panoramic camera device 100 according to various embodiments of the disclosure. Although one implementation is shown in FIG. 1 and described herein, a stereoscopic panoramic camera device 100 according to an embodiment of the disclosure more generally comprises a camera device that can provide stereoscopic panoramic images and/or video in digital form. The stereoscopic panoramic camera device 100 includes a plurality of lens systems 101 that convey images of viewed scenes to a respective plurality of image sensors 102. By way of example, the image sensors 102 each comprise a respective charge-coupled device (CCD) or a complementary metal oxide semiconductor (CMOS) sensor that is driven by one or more sensor drivers. In the context of this disclosure, a lens system 101 can also comprise a combination of a lens and one or more mirror systems that reflect light from a configured field of view to a corresponding image sensor 102. For example, a parabolic mirror system can be coupled to a lens to potentially reflect light from a 360 degree field of view into a corresponding image sensor 102. The analog image signals captured by the sensors 102 are provided to an analog front end 104 for conversion into binary code that can be processed by a controller 108 or processor.

The controller 108 executes various types of logic that can be available in program memory 110 accessible to the stereoscopic panoramic camera device 100 in order to facilitate the functionality described herein. In other words, the controller 108 can place the stereoscopic panoramic camera device 100 into various modes, such as an image capture mode that facilitates capture of stereoscopic panoramic images and/or a video capture mode that allows a user to capture video. Additionally, as described herein, the controller 108 can place the stereoscopic panoramic camera device 100 in an object detection mode whereby the stereoscopic panoramic camera device 100 facilitates detection of the distance of objects relative to the stereoscopic panoramic camera device 100 from a depth map generated in the image capture mode. As another example, the controller 108 can place the stereoscopic panoramic camera device 100 in a display mode that facilitates display of stereoscopic panoramic images and/or video captured by the device in an integrated local display 109 and/or via an externally coupled display via the device input/output 105 capabilities, which can be coupled to a display device.

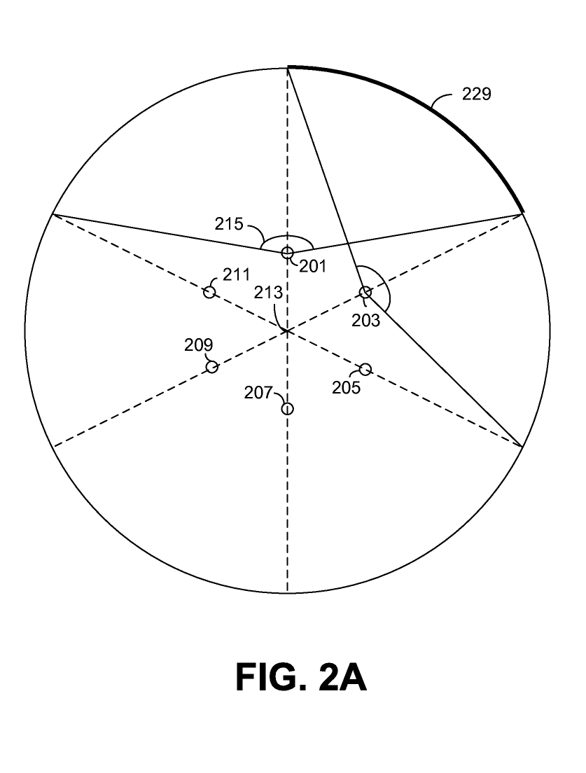

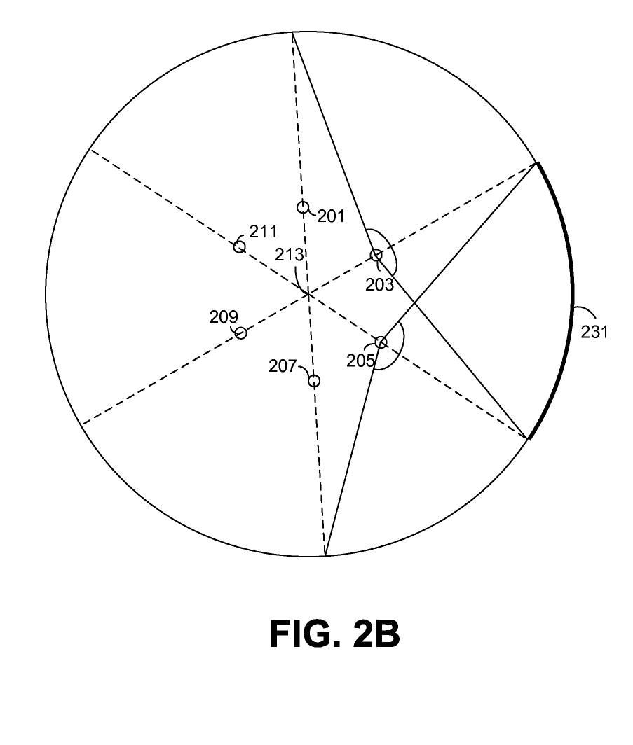

Accordingly, the stereoscopic panoramic image capture logic 115 in the program memory 110 is executed by the controller 108 to facilitate capture of stereoscopic panoramic imagery from a plurality of image sensors 102 coupled to a respective plurality of lens systems 101. In some embodiments, the plurality of image sensors 102 and lens systems 101 can represent multiple cameras that are arranged around a center point to capture a 360 degree field of view around the center point and that are in communication with the controller 108 via a data bus, network or some other mode of communication. As is described below and shown in the examples of FIGS. 2-5, the plurality of image sensors 102 in a stereoscopic panoramic camera device 100 can include a plurality of camera devices arranged around a center point such that the plurality of camera devices collectively captures a 360 degree field of view around the center point. Accordingly, the stereoscopic panoramic image capture logic 115 can initiate image capture in the various image sensors 102 surrounding the center point and assemble a stereoscopic panoramic image from the data obtained from the image sensors 102.

The stereoscopic panoramic image capture logic 115 can also generate a depth map from the stereoscopic panoramic image. The stereoscopic panoramic image capture logic 115 can also facilitate storage of a stereoscopic panoramic image in a mass storage 141 element associated with the stereoscopic panoramic camera device 100. Example arrangements of how the image sensors 102 are arranged and how a stereoscopic panoramic image can be assembled from image data captured by the image sensors 102 is discussed in more detail with reference to FIGS. 2-5.

The object detection logic 117 is executed by the controller 108 to facilitate detection of objects from the depth map associated with a stereoscopic panoramic image. As described above, the object detection logic 117 can facilitate robotics applications, automotive application, or any other applications for which object detection and/or detection of distance of objects from the stereoscopic panoramic camera device 100 can be used. The display logic 119 can facilitate display of a stereoscopic panoramic image captured by the stereoscopic panoramic camera device 100 in an integrated display 109 and/or an external display via the device input/output 105 interface, which can include a digital visual interface (DVI) port, a high-definition multimedia interface (HDMI) port, or any other interface that can communicate with an external display.

Reference is now made to FIG. 2, which illustrates one example of an arrangement of camera devices 201, 203, 205, 207, 209, 211 and/or lens systems coupled with image sensors that are positioned around a center point 213. In the depicted arrangement, the controller 108 is configured to obtain imagery from the various camera devices and assemble a stereoscopic panoramic image from the various camera devices. In the depicted example, the stereoscopic panoramic camera device 100 comprises six camera devices 201, 203, 205, 207, 209, 211 arranged around the center point 213. However, it should be appreciated that the stereoscopic panoramic camera device 100 can also comprise a greater or fewer number of camera devices so long as they collectively are positioned to capture a 360 degree field of view.

In the example of FIG. 2A, each of the camera devices, such as, for example, camera device 201, is configured with a respective lens system having a particular angular field of view 215. Accordingly, an adjacent camera device 203 in the stereoscopic panoramic camera device 100 is configured with another respective lens system having another angular field of view 217. Therefore, these adjacent camera devices 201, 203 are configured with an overlapping field of view such that a sector 229 is formed at which both of the adjacent camera devices 201, 203 are aimed. Therefore, the stereoscopic panoramic image capture logic 115 can initiate capture of image data from the camera devices 201, 203 and designate a portion of the field of view captured by the camera device 201 corresponding to the sector 229 as the left view of the sector and a portion of the field of view captured by the camera device 203 corresponding to the sector 229 as the right view of the sector. Similarly, as shown in FIG. 2B, the stereoscopic panoramic image capture logic 115 can designate a portion of the field of view captured by the camera device 203 corresponding to a sector 231 that is adjacent to sector 229. For this adjacent sector 231, the stereoscopic panoramic image capture logic 115 can designate a portion of the field of view captured by the camera device 203 as the left view of the sector and a portion of the field of view captured by the camera device 205 corresponding to the sector as the right view of the sector.

Therefore, in this way, the stereoscopic panoramic image capture logic 115 can initiate capture of image data from the various camera devices in the stereoscopic panoramic camera device 100 that are positioned around the center point 213 and extract a left image and a right image for each of the sectors so that at least two images corresponding to each sector are captured. A subset of the image data captured by each of the camera devices can be extracted to form one of a left image or a right image corresponding to a given sector. Therefore, because at least two images corresponding to each sector can be extracted from the image data captured by each of the camera devices, a stereoscopic panoramic image can be generated from the image data captured by the various camera devices in the stereoscopic panoramic camera device 100.

Therefore, the stereoscopic panoramic image capture logic 115 can stitch together right images corresponding to each of the sectors to assemble a right panoramic image. The right panoramic image corresponds to each of the right images designated for each of the sectors comprising a 360 degree field of view. Therefore, each of the right images that are stitched together to form a right panoramic image can be taken from various lens systems from the camera devices from a plurality of camera devices comprising the stereoscopic panoramic camera device 100. Additionally, the stereoscopic panoramic image capture logic 115 may extract a subset of the image data captured by a respective camera corresponding to a particular sector as a right or left image for respective sector because, as is shown in the example, the field of view of a particular camera device may extend beyond a particular sector with which its field of view overlaps with an adjacent camera device. Similarly, the stereoscopic panoramic image capture logic 115 can stitch together left image corresponding to each of the sectors to assemble a left panoramic image. Therefore, because the stereoscopic panoramic image capture logic 115 can assemble a left panoramic image and a right panoramic image from the camera devices comprising the stereoscopic panoramic camera device 100, the right and left panoramic images respectively comprise stereoscopic information from which a stereoscopic panoramic image can be generated.

The stereoscopic panoramic camera device 100 can comprise various permutations and combinations of camera devices, lens systems, and/or image sensors that are configured to capture a 360 degree field of view around a center point of the stereoscopic panoramic camera device 100. In the depicted example of FIGS. 2A-2B, the stereoscopic panoramic camera device 100 comprises six camera devices that are equidistantly positioned around the center point 213 and aimed at a perimeter surrounding the stereoscopic panoramic camera device 100. It should be appreciated that in some embodiments, the various camera devices may not be equidistantly placed around a center point 213 so long as the distance of each camera device from the center point 213 is known such that a geometric transformation received from each of the camera devices can be performed that produces stereoscopic image data of a 360 degree field of view around a center point. It should also be appreciated that the camera devices comprising the stereoscopic panoramic camera device 100 can include two omnidirectional camera devices that are configured to capture a full 360 degree field of view around a center point. An omnidirectional camera device can comprise, for example, a camera device including one or more parabolic mirrors that direct light from a 360 field of view into an image sensor. Accordingly, the stereoscopic panoramic image capture logic 115 can perform a reverse geometric transformation of the image data captured by at least two omnidirectional cameras to product a left and right panoramic image corresponding to the 360 degree field of view around the center point.

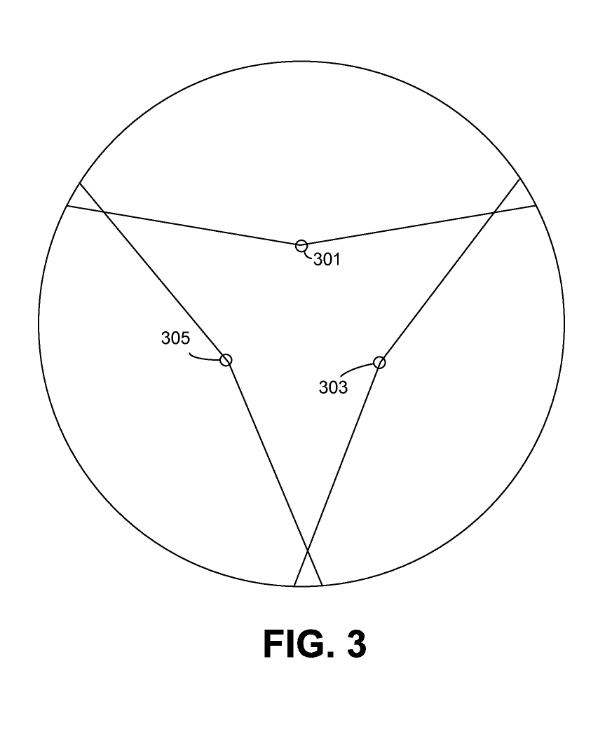

Accordingly, reference is now made to FIG. 3, which illustrates an alternative embodiment of a stereoscopic panoramic camera device 100. In the depicted alternative embodiment, the stereoscopic panoramic camera device 100 comprises three camera devices that are equidistantly spaced around a center point of the stereoscopic panoramic camera device 100. The camera devices 301, 303, 305 collectively capture a 360 degree field of view surrounding the center point. As shown in the depicted example, each of the camera devices comprise overlapping fields relative to an adjacent camera device such that a left and right image for each sector surrounding the center point can be assembled by the stereoscopic panoramic image capture logic 115.

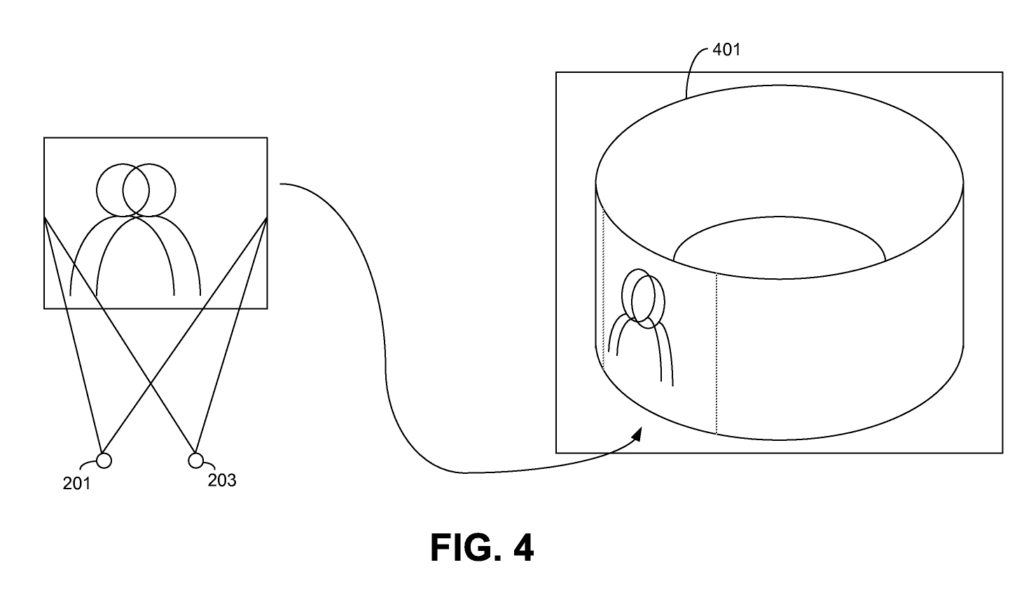

Reference is now made to FIG. 4, which illustrates an example of how a stereoscopic panoramic image can be generated from the stereoscopic panoramic camera device 100 according to various embodiments of the disclosure. In the example of FIG. 4 camera devices 201 and 203 are shown from the stereoscopic panoramic camera device 100 example of FIGS. 2A-2B. Accordingly, a left image and right image corresponding to a sector that represents an overlapping field of view of the camera devices 201 and 203. As noted above, the left image and right image can be extracted by the stereoscopic panoramic image capture logic 115 from image data received from respective image sensors of the camera devices 201 and 203, which may represent a subset of the image data captured by the camera devices 201 and 203.

Accordingly, the left image and right image captured by the camera devices 201 and 203 can be assembled into a stereoscopic panoramic image 401 that comprises a left image and right image of a 360 field of view around a center point. A right panoramic image and left panoramic image, respectively, can be stitched together using image processing techniques known in the art. The stereoscopic panoramic image 401 can also be generated and/or displayed from the point of view of an observer located in any arbitrary location with respect to a location of each of the camera devices of the stereoscopic panoramic camera device 100. Accordingly, the display logic 119 can perform a geometric transformation of the left panoramic image and right panoramic image based upon the location of the observer. For example, in the case of a videoconferencing system providing an immersive stereoscopic panoramic experience, a stereoscopic panoramic image and/or video can be generated from the point of view of a user.

Additionally, the display logic 119 can also transform the stereoscopic panoramic image 401 onto a flat display in the form of an anaglyph image so that the stereoscopic panoramic image 401 can be observed with 3D glasses by an observer. Accordingly, the display logic 119 can generate the stereoscopic panoramic image 401 using depth map information together with stereoscopic panoramic image data such that the depth map information is employed to position objects in the stereoscopic panoramic image 401 at a relative distance from one another in the anaglyph image. For example, a first object positioned in front of a second object are remapped in an anaglyph image such that the first object appears closer to the observer than the second object from the perspective of the observer.

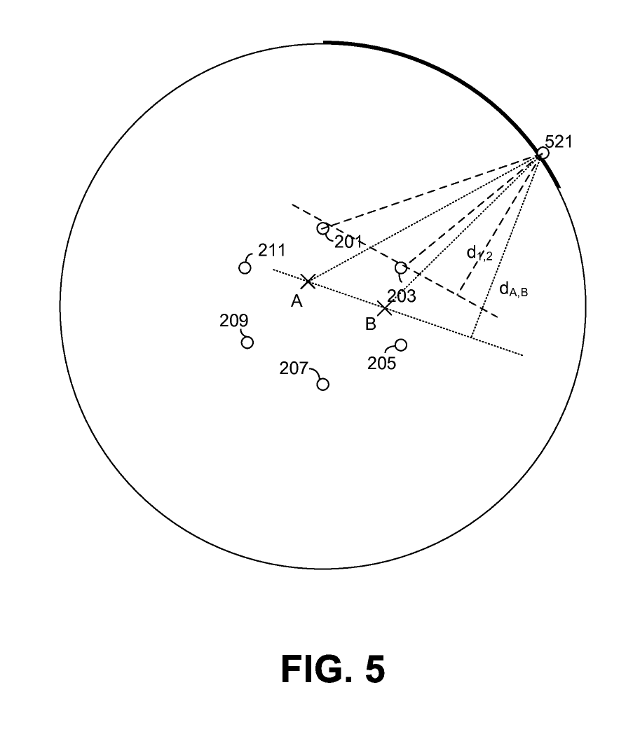

Accordingly, reference is now made to FIG. 5, which illustrates an example of how a stereoscopic panoramic image can be rendered and/or viewed from the point of view of an observer. As noted above, a depth map representing a distance to objects in a stereoscopic panoramic image can be generated from the stereoscopic information captured by the stereoscopic panoramic camera device 100. Accordingly, the display logic 119 can determine from such a depth map a normal distance from the camera devices 201 and 203 to an object 521 and/or a point in the stereoscopic panoramic image at which the observer is focused. Additionally, the display logic 119 can also determine a normal distance from the left and right eyes A, B, of an observer to the same point. Therefore, the display logic 119 can perform a geometric transformation of the stereoscopic panoramic image that adjusts the image to account for a difference between the distance of the object from the camera devices 201 and 203 and the distance of the object from the observer.

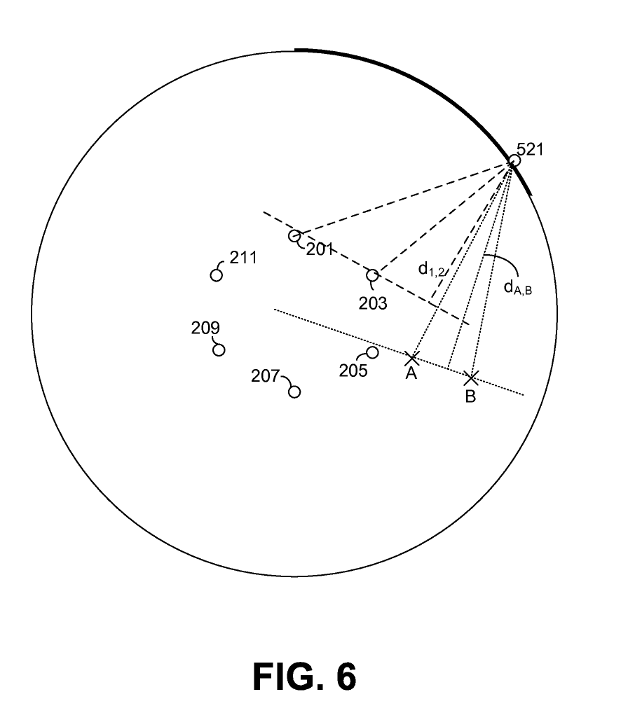

Continuing this example, reference is now made to FIG. 6, which illustrates the left and right eyes A, B, of an observer located at a different position. Accordingly, based upon the depth map information acquired by the display logic 119, the display logic 119 can remap the stereoscopic panoramic image generated above for the observer in FIG. 5 as if it were acquired at the repositioned location of the observer using a geometric transformation, as the location of the camera devices 201 and 203 from the object 521 and/or a point in the stereoscopic panoramic image is known, as is the distance of the left and right eyes, A, B, of the observer from the same location.

As noted above, a stereoscopic panoramic camera device 100 can be employed in various applications. For example, in an automotive application, a stereoscopic panoramic camera device 100 can comprise camera devices positioned around the perimeter of a vehicle for real time collision detection applications. In such an application, the stereoscopic panoramic camera device 100 can comprise, for example, a camera device positioned at each corner of a vehicle such that adjacent camera devices have a partially overlapping field of view with an adjacent camera device. Accordingly, the stereoscopic panoramic image capture logic 115 can initiate periodic capture of a stereoscopic panoramic image as well as creation of a depth map from the stereoscopic information captured by the camera devices. Object detection logic 117 can detect objects in the stereoscopic panoramic imagery, and from the depth map, can generate an alert if an object is within a proximity threshold and/or relative velocity threshold of the vehicle.

As an alternative example of an application in which a stereoscopic panoramic camera device 100 can be employed, the stereoscopic panoramic camera device 100 can be utilized in a robotics application for navigation purposes. For example, in such a robotics application, a stereoscopic panoramic camera device 100 can comprise camera devices positioned such that a 360 degree field of view around a robotics device is captured. The camera devices can be numbered and oriented such that at least two images corresponding to the entire 360 degree field of view are captured by the camera devices.

Accordingly, the stereoscopic panoramic image capture logic 115 can generate stereoscopic panoramic imagery corresponding to the 360 field of view as well as a corresponding depth map. Therefore, object detection logic 117 can detect objects, obstacles, or other items in the path of a stereoscopic panoramic image to facilitate robotic navigation of a robotic device itself, robotic arms or other appendages, etc. As yet another example, in a videoconferencing application, a stereoscopic panoramic camera device 100 can be employed to capture a stereoscopic panoramic image of a room with which a user is engaging in a videoconference. Accordingly, display logic 119 can display at least a portion of the stereoscopic image and/or video captured by the stereoscopic panoramic camera device 100 via a display device that is visible to the user to produce an immersive three dimensional videoconferencing experience.

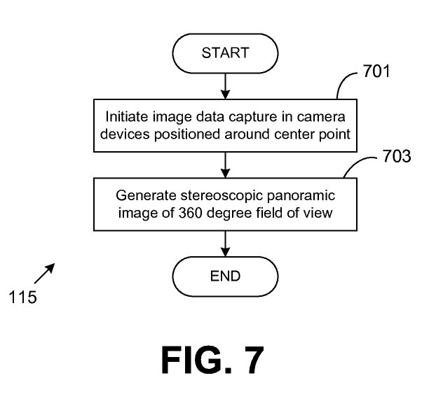

Referring next to FIG. 7, shown is a flowchart that provides one example of the operation of a portion of the image capture logic 115 according to various embodiments. It is understood that the flowchart of FIG. 7 provides merely an example of the many different types of functional arrangements that may be employed to implement the operation of the portion of logic executed in the stereoscopic panoramic camera device 100 as described herein. As an alternative, the flowchart of FIG. 7 may be viewed as depicting an example of steps of a method implemented in the stereoscopic panoramic camera device 100 according to one or more embodiments. In box 701, the image capture logic 115 can initiate capture of image data by the various camera devices comprising the stereoscopic panoramic camera device 100. The capture image data represents a full 360 degree field of view around a center point. In box 703, the image capture logic 115 generates a stereoscopic panoramic image of a 360 degree field of view around the center point.

Embodiments of the present disclosure can be implemented in various devices, for example, having a processor, memory, and image capture hardware. The logic described herein can be executable by one or more processors integrated with a device. In one embodiment, an application executed in a computing device, such as a mobile device, can invoke API's that provide the logic described herein as well as facilitate interaction with image capture hardware. Where any component discussed herein is implemented in the form of software, any one of a number of programming languages may be employed such as, for example, processor specific assembler languages, C, C++, C#, Objective C, Java, Javascript, Perl, PHP, Visual Basic, Python, Ruby, Delphi, Flash, or other programming languages.

As such, these software components can be executable by one or more processors in various devices. In this respect, the term “executable” means a program file that is in a form that can ultimately be run by a processor. Examples of executable programs may be, for example, a compiled program that can be translated into machine code in a format that can be loaded into a random access portion of memory and run by a processor, source code that may be expressed in proper format such as object code that is capable of being loaded into a random access portion of the memory and executed by the processor, or source code that may be interpreted by another executable program to generate instructions in a random access portion of the memory to be executed by the processor, etc. An executable program may be stored in any portion or component of the memory including, for example, random access memory (RAM), read-only memory (ROM), hard drive, solid-state drive, USB flash drive, memory card, optical disc such as compact disc (CD) or digital versatile disc (DVD), floppy disk, magnetic tape, or other memory components.

Although various logic described herein may be embodied in software or code executed by general purpose hardware as discussed above, as an alternative the same may also be embodied in dedicated hardware or a combination of software/general purpose hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon an application of one or more data signals, application specific integrated circuits having appropriate logic gates, or other components, etc. Such technologies are generally well known by those skilled in the art and, consequently, are not described in detail herein.

Also, any logic or application described herein that comprises software or code, such as the stereoscopic panoramic image capture logic 115, can be embodied in any non-transitory computer-readable medium for use by or in connection with an instruction execution system such as, for example, a processor in a computer device or other system. In this sense, the logic may comprise, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. The computer-readable medium can comprise any one of many physical media such as, for example, magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

Therefore, having thus described the invention, at least the following is claimed:

1. A stereoscopic panoramic camera device, comprising:
a plurality of camera devices positioned about a center point, the plurality of camera devices configured to capture image data corresponding to a field of view around the center point;
at least one processor executing image capture logic, the image capture logic comprising:
logic that initiates capture of the image data in the plurality of camera devices, the image data corresponding to the field of view; and
logic that generates a stereoscopic panoramic image of the field of view by generating stereoscopic information for each of a plurality of sectors surrounding the center point, wherein the stereoscopic information is generated from adjacent camera devices having an overlapping field of view.

2. The stereoscopic panoramic camera device of claim 1, wherein the plurality of camera devices comprises a first camera device, a second camera device, and a third camera device, wherein each of the plurality of camera devices are positioned equidistantly from the center point and equidistantly from the respective others of the plurality of camera devices.

3. The stereoscopic panoramic camera device of claim 1, wherein the plurality of camera devices comprises at least two camera devices positioned around the center point, wherein the at least two camera devices respectively comprise an omnidirectional camera.

4. The stereoscopic panoramic camera device of claim 1, wherein the logic that generates the stereoscopic panoramic image of the field of view further comprises:
logic that identifies a plurality of sectors around the center point, each of the sectors being defined by an overlapping field of view of at least two of the camera devices; and
logic that obtains a left image and a right image for each of the sectors, the left image captured from a first of the at least two of the camera devices and the right image captured from a second of the at least two of the camera devices.

5. The stereoscopic panoramic camera device of claim 4, further comprising display logic executed by the at least one processor, the display logic comprising:
logic that determines a position of an observer of the stereoscopic panoramic image;
logic that determines an orientation of the observer; and
logic that performs a geometric adjustment of the stereoscopic panoramic image based upon a distance of the observer from a respective position of the plurality of camera devices and the orientation of the observer.

6. The stereoscopic panoramic camera device of claim 4, wherein the image capture logic further comprises logic that assembles a panoramic stereoscopic image from the left image and the right image for each of the sectors.

7. The system of claim 1, wherein the image capture logic further comprises logic that generates a depth map corresponding to the field of view from the stereoscopic information.

8. The stereoscopic panoramic camera device of claim 7, further comprising object detection logic executed by the at least one processor, the object detection logic comprising logic that detects an object within a proximity threshold of the stereoscopic panoramic camera device from the depth map.

9. A method executed in a stereoscopic panoramic camera device, comprising:
initiating capture of the image data in a plurality of camera devices positioned about a center point, the plurality of camera devices configured to capture image data corresponding to a 360 degree field of view around the center point, the image data corresponding to the 360 degree field of view; and
generating a stereoscopic panoramic image of the 360 degree field of view by generating stereoscopic information for each of a plurality of sectors surrounding the center point, wherein the stereoscopic information is generated from adjacent camera devices having an overlapping field of view.

10. The method of claim 9, wherein the plurality of camera devices comprises at least two camera devices, wherein each of the at least two camera devices are configured with a parabolic mirror lens system configured to capture image data corresponding to the 360 degree field of view.

11. The method of claim 9, wherein the plurality of camera devices comprises at least two camera devices positioned around the center point, wherein the at least two camera devices respectively comprise an omnidirectional camera.

12. The method of claim 9, wherein generating the stereoscopic panoramic image of the 360 degree field of view further comprises:
identifying a plurality of sectors around the center point, each of the sectors being defined by an overlapping field of view of at least two of the camera devices; and
obtaining a left image and a right image for each of the sectors, the left image captured from a first of the at least two of the camera devices and the right image captured from a second of the at least two of the camera devices.

13. The method of claim 12, further comprising:
determining a position of an observer of the stereoscopic panoramic image;
determining an orientation of the observer; and
performing a geometric adjustment of the stereoscopic panoramic image based upon a distance of the observer from a respective position of the plurality of camera devices and the orientation of the observer.

14. The method of claim 12, further comprising assembling a panoramic stereoscopic image from the left image and the right image for each of the sectors.

15. The method of claim 9, further comprising generating a depth map corresponding to the 360 degree field of view from the stereoscopic information.

16. The method of claim 15, further comprising detecting an object within a proximity threshold of a stereoscopic panoramic camera device based upon the depth map.

17. The method of claim 15, further comprising generating a collision warning when an object is within a proximity threshold of a stereoscopic panoramic camera device.

18. A system, comprising:
a plurality of image capture means positioned about a center point, the plurality of image capture means configured to capture image data corresponding to a 360 degree field of view around the center point;
at least one processing means executing image capture logic, the image capture logic comprising:
means for initiating capture of the image data in the plurality of camera devices, the image data corresponding to the 360 degree field of view; and
means for generating a stereoscopic panoramic image of the 360 degree field of view by generating stereoscopic information for each of a plurality of sectors surrounding the center point, wherein the stereoscopic information is generated from adjacent camera devices having an overlapping field of view.

19. The system of claim 18, wherein the plurality of image capture means comprises a first image capture means, a second image capture means, and an image capture means, wherein each of the plurality of image capture means are positioned equidistantly from the center point and equidistantly from the respective others of the plurality of image capture means.

20. The system of claim 18 wherein the plurality of image capture means comprises at least two image capture means devices positioned around the center point, wherein the at least two image capture means respectively comprise an omnidirectional camera configured to capture a 360 degree field of view around the center point.
